(19) United States
(12) Patent Application Publication
(10) Pub. No.: US 2009/0006071 A1
(43) Pub. Date: Jan. 1, 2009

(54) Methods for Definition and Scalable Execution of Performance Models for Distributed Applications

(75) Inventors: Pavel A. Dournov, Redmond, WA (US); John Morgan Oslake, Seattle, WA (US); Glenn R. Peterson, Kenmore, WA (US); Jonathan C. Hardwick, Kirkland, WA (US); Hemanth Kaza, Sammamish, WA (US)

Correspondence Address: LEE & HAYES PLLC, 601 W Riverside Avenue, Suite 1400, SPOKANE, WA, 99201, US

(73) Assignee: Microsoft Corporation, Redmond, WA (US)

(21) Appl. No.: 11/772,059

(22) Filed: Jun. 29, 2007

(51) Int. Cl. G06F 9/455

(52) U.S. Cl. 703/22

(57) ABSTRACT

A method and system for defining performance models of distributed applications such as distributed systems or network systems in a way that combines discrete and analytical models and simulating such performance models for analyzing software performance and impacts on devices of the distributed applications is described. Also described is a method for accelerating the simulation process by converting the discrete load into aggregate load dynamically based on the statistical analysis of the simulation results.

### BACKGROUND

Simulation of distributed applications may be performed to test utilization of hardware devices and performance of the distributed applications. The simulation may be directed to perform desired actions without having to actually produce or provide devices and/or arrange such devices into a desired distributed system configuration. Such traditional simulation techniques may be overly complicated with regard to model development and configuration and result in great inefficiencies, especially when simulating distributed applications due to a relatively large number of repetitive operations performed by discrete event simulators. Therefore, there is a continuing need for techniques that improve performance of device simulation tools, especially in distributed systems.

Performance modeling using discrete event simulation may require building detailed models of software and hardware resources consumed by (i.e., used by) the software. Performance modeling may also require individually determining metrics that specify resource consumption (i.e., hardware resource usage) for transactions and resource type. The value received from such models usually exceeds the effort of building the models, since detailed discrete models can be used in many various modeling scenarios and, most importantly, such models allow estimating the statistical characteristics of the response time for individual business functions (transactions) performed by the modeled software. Other scenarios that benefit from the detailed discrete models include but are not limited to, evaluating service level (i.e., transaction latencies, etc.) performance effects of architecture changes, workload changes, etc.

Being able to predict the service level parameters such as transaction latencies is not equally important for all transactions performed by a distributed application from the point of view of an application quality of service stand point. Some of the transactions are closely related to core business activities of a user, while others might merely represent maintenance functions. Knowing the latencies of the maintenance transactions may be less valuable than making sure that the core business functions (i.e., transactions) can be performed within the preset service level ranges. Therefore the efforts for building performance model of the maintenance transactions can be reduced by reducing the level of details at which such transactions are modeled.

### SUMMARY

This summary is provided to introduce simplified concepts of methods for definition and scalable execution of performance models for distributed applications, which is further described below in the Detailed Description. This summary is not intended to identify essential features of the claimed subject matter, nor is it intended for use in determining the scope of the claimed subject matter.

In an embodiment, performance models of distributed applications are constructed. The performance models define aggregated continuous resource consumptions along with discrete resource actions. This allows for flexibility in defining performance models to better match the modeling scenarios.

### BRIEF DESCRIPTION OF THE CONTENTS

The detailed description is described with reference to the accompanying figures. In the figures, the left-most digit(s) of a reference number identifies the figure in which the reference number first appears. The use of the same reference number in different figures indicates similar or identical items.

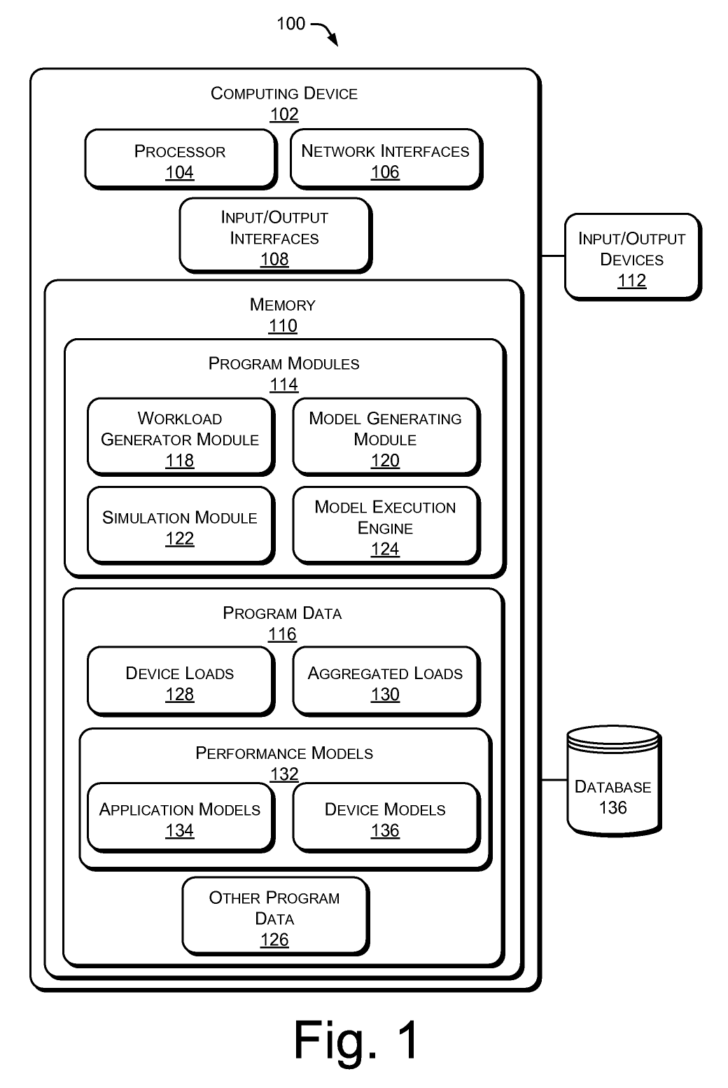

FIG. 1 is an illustration of an exemplary system for simulating a distributed system for analyzing impact on devices of the distributed system and performance characteristics of the software, according to one embodiment.

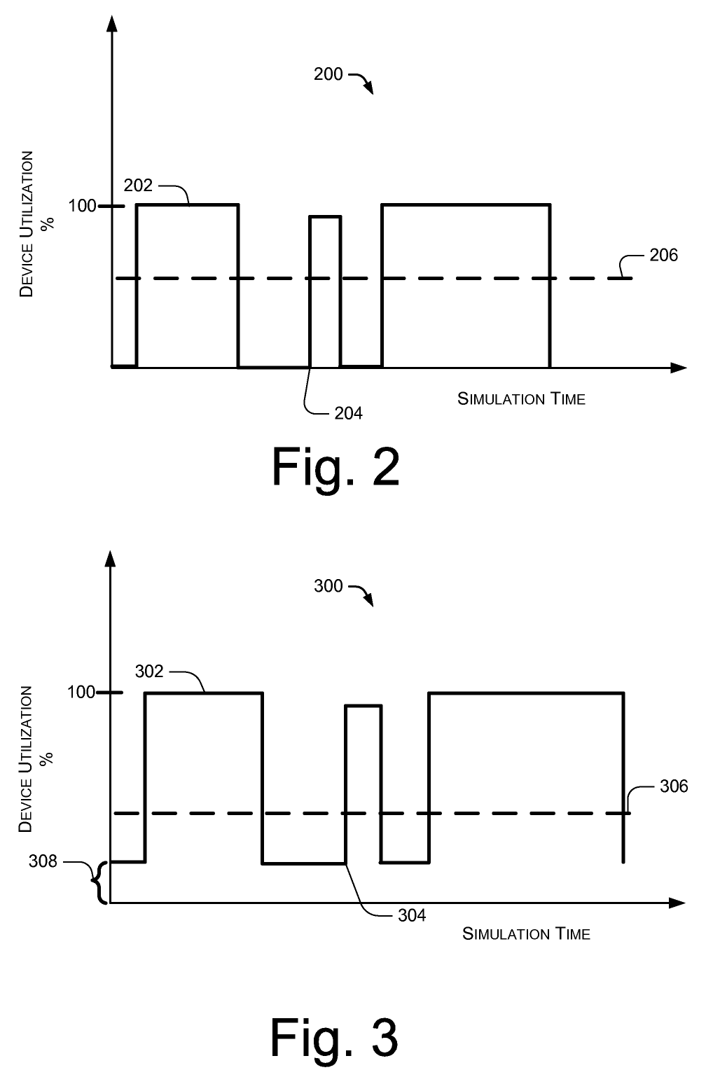

FIG. 2 is an illustration of device utilization changes during simulation once aggregated load is not considered.

FIG. 3 is an illustration of device utilization changes during simulation once aggregated load is considered.

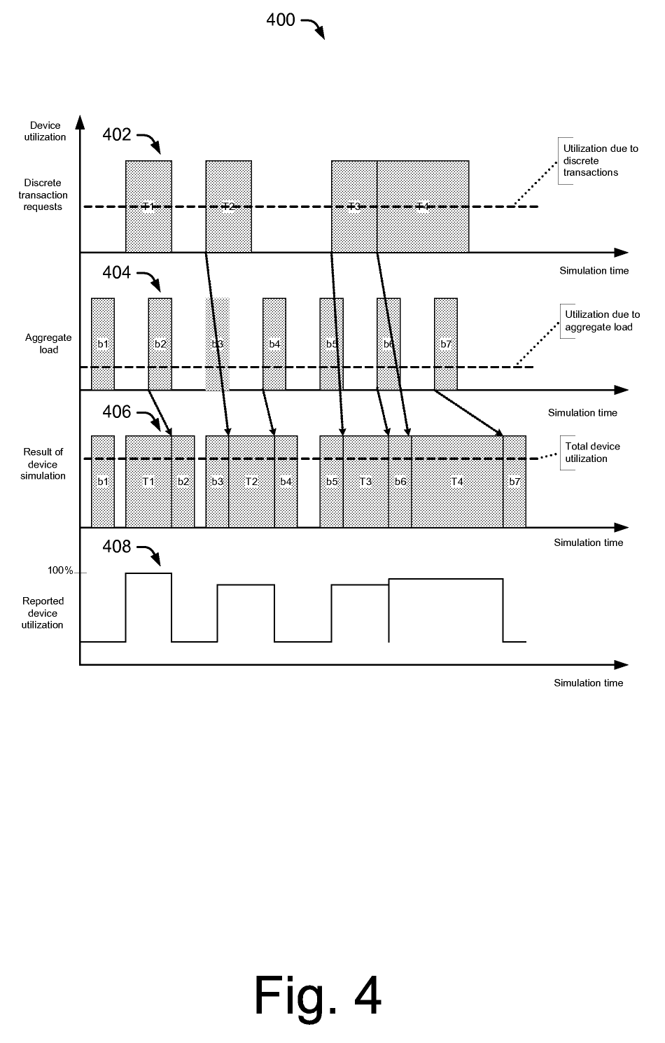

FIG. 4A is an illustration of comparison between transactions and device utilization according to one approach of performance analysis using simulation.

FIG. 4B is an illustration of comparison between requests generated from an agregated load and device utilization according to one approach of performance analysis using simulation.

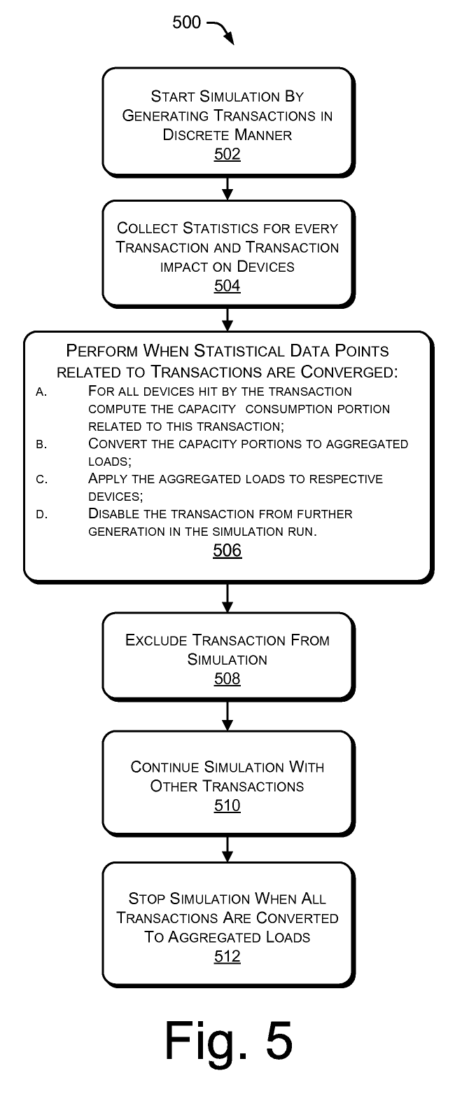

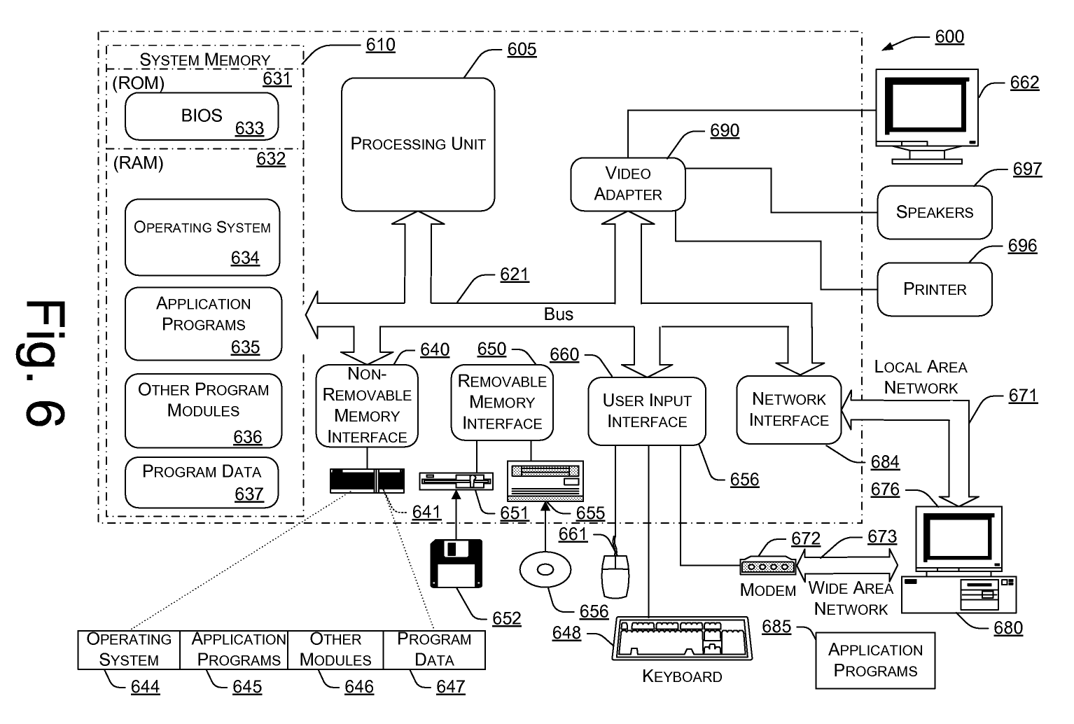

FIG. 5 is a flowchart of an exemplary method for simulating workload from a performance models of distributed applications.

FIG. 6 is an illustration of an exemplary computing device.

### DETAILED DESCRIPTION

Described is a method for defining performance models in a way that allows combining both discrete detailed models and aggregated models of less important transactions. A method is proposed for executing the combined (hybrid) models.

The method for executing the combined models allows for improvement possibility in the area of accelerating the simulation by reducing the number of redundant computations. The method further provides for a gradual migration of discrete transactions towards the aggregated load during model simulation based on the statistical characteristics of the simulation results, which leads to better scalability of the simulation engine and allows executing greater variety of model scales. The method also simplifies the model definition as it allows for more flexible options for the application instrumentation.

The following describes techniques for combining discrete simulation of performance models and analytical performance analysis techniques for distributed applications (i.e., a distributed system or network systems) for analyzing software performance and the impacts of software on devices in such systems. The performance models may include building models of software and hardware resources consumed by software applications. The performance models enable estimation of statistical characteristics of response times for transactions (e.g., individual business functions) performed by modeled software, device utilization, and various other parameters describing the performance of the distributed application. Such models may be used to evaluate service level performance effects of architecture changes, workload increases, etc.

Transaction models are defined by transaction sources. Transaction sources represent transaction originating points. Transactions start at the transaction sources. An application model transaction source can represent real users performing certain business functions or software services that are out of the modeling scope and considered as consumers of the application services. For example, an application model user may be a Microsoft® Outlook messaging application sending requests to an Microsoft® Exchange message service. In this case, the user transactions correspond to the real user interactions with the Outlook user interface. Another example is a remote SMTP service, since it is out of scope of the modeling application it is represented as a transaction source sending SMTP requests that are treated as client transactions.

An application model may include service models defining services of the application and methods defining methods of a service. The application model further includes definitions of transactions. During simulation transaction sources initiate transactions that invoke service methods which can invoke other methods, this defines the action flow to process the transactions.

Structures and principles for defining detailed discrete models of distributed applications are incorporated by reference to U.S. patent application entitled “Dynamic Transaction Generation For Simulating Distributed Systems” by Efstathios Papaefstathiou, John M. Oslake, Jonathan C. Hardwick, and Pavel A. Dournov; having Ser. No. 11/394,474, filed on Mar. 31, 2006.

The schemas and methods described in the reference application are particularly extended to define application models in order to define non-transactional aggregated loads. An aggregated load element is provided to an application component definition schema to enable declaring named units of continuous resource consumption referred to as “aggregated load”. Since the aggregate load is continuous, an implication is made that the transaction latency cannot be computed for this application activity simply because the activity is not described as a transaction.

The principal difference between a discrete and aggregated load definition is in the units of the load specification values and the level of abstraction at which the load is represented. For example, the discrete CPU load is specified in the units of “CPU cycles per transaction” meaning that every transaction of the given type consumes that many CPU cycles on an average. Thus, the average CPU utilization can be computed as the ratio of the total consumed CPU cycles consumed by all transactions over given period, and the total number of CPU cycles that the given CPU is able to run over the same period of time. Furthermore, the knowledge of the CPU speed (i.e., cycles per second) and other CPU parameters that affect CPU performance allow to determine latency of each individual transaction.

In contrast to a discrete load, the aggregated load (also referred to as continuous load) may be specified, for example, in the units of “CPU cycles per second”. In practice, the load may be attributed to some discrete activity on the computer system, but for illustration of the model description, the discrete activity can be represented through its average effect on a resource. This is a more general model of the workload which enables a simpler model definition at the expense of voiding the ability to compute transaction latencies. Additional details of executing models that contain the aggregated load definitions are described below.

Some transactions may be closely related to core business activities of the user, while others are mostly maintenance functions. Since the latency of the maintenance functions may be less valuable from the point of view of key system performance indicators than performing core business functions within the preset service level ranges, the efforts for building the performance models of maintenance functions can be reduced by reducing the level of details at which such functions are modeled. Therefore, in the described method both discrete detailed models and high-level models of less important functions are combined to form the full performance models and executed to analyze the performance of the distributed applications.

The techniques described herein may be used in many different operating environments and systems. Multiple and varied implementations are described below. An exemplary environment that is suitable for practicing various implementations is discussed in the following section.

### EXEMPLARY SYSTEM

Exemplary systems and methods are discussed for generating performance models of distributed applications such as distributed systems or network systems and simulating such performance models for analyzing transactions impacts on devices of the distributed applications are described in the general context of computer-executable instructions (program modules) being executed by a computing device such as a personal computer. Program modules generally include routines, programs, objects, components, data structures, etc., that perform particular tasks or implement particular abstract data types. While the systems and methods are described in the foregoing contexts, acts and operations described hereinafter may be implemented in hardware or other forms of computing platforms.

FIG. 1 shows an exemplary system 100 that may be used for generating performance models for distributed applications and simulating the performance models for analyzing transactions impacts on devices of such systems and characteristics of the response time for each transaction. The system 100 includes a computing device 102. Computing device 102 may be a general purpose computing device, a server, a laptop, a mobile computing device, etc.

Computing device 102 includes a processor 104, network interfaces 106, input/output interfaces 108, and a memory 110. Processor 104 may be a microprocessor, a microcomputer, a microcontroller, a digital signal processor, a dual core processor, and so on. Network interfaces 106 provide connectivity to a wide variety of networks and protocol types, including wire networks (e.g., LAN, cable, etc.) and wireless networks (e.g., WLAN, cellular, satellite, etc.).

Input/output interfaces 108 provide data input and output capabilities for system 100. In the illustrated example, computing device 102 receives data in the form of instructions from users to obtain device specific information of various devices of the distributed system or network system, through input/output interfaces 108. Input/output interfaces 108 may include, for example, a mouse port, a keyboard port, etc. Input/output devices 112 may be employed to feed the instructions to the input/output interfaces 108. Examples of input/output devices 112 include a keyboard, a mouse, etc.

Memory 110 can include a volatile random access memory (e.g., RAM) and a non-volatile read-only memory (e.g., ROM, flash memory, etc.). In this example, memory 110 comprises program modules 114 and program data 116. Program modules 114 may include a workload generator 118, a model generating module 120, a simulation engine or simulating module 122 and a model execution engine module 124.

In this example, the workload generator 118 may process the user instructions received by computing device 102 in order to identify device specific information to be collected. Computing device 102 may be “generic”, meaning that computing device 102 is not by itself “aware”, of particulars of any specific devices of distributed applications. To obtain the device specific information (i.e., a part of other program data 126), computing device 102 may be configured to communicate via network interfaces 106 with a plurality of pre-created device models based on the user instructions. The device information may include particulars of the specific devices. Utilization rates of the specific devices for various transactions and latencies of the various transactions may be outputs of the simulating module 122. The user instructions can include reference of specific devices of pre-created device models to be communicated.

In an implementation, data acquisition module 118 directly interacts with the pre-created models, identifies the specific devices and obtains the device specific information. In such an implementation, the user may indicate the pre-created models to be simulated.

Each of the plurality of pre-created device models may correspond to a particular device type, such as a central processing unit (CPU), a storage device (e.g., hard disk, removable memory device, and so on), a network interface card (NIC), a network switch, etc.

Data acquisition module 118 categories the device information as device loads 128 and aggregated loads 130. Device loads 128 include workloads of hardware devices for performing hardware actions as part of primary end user transactions. Aggregated loads 130 include continuous workload definitions for hardware devices for performing secondary end user transactions and collections of secondary end user transactions in the distributed system or network system. Such secondary end user transactions may be transactions that may be performed automatically of by the users occasionally and for which the latency computation is not required by the modeling scenario.

For example, in the Microsoft® Exchange application model, data acquisition module 118 collects device specific information of computing devices connected to mailbox server(s) over a network, mailbox server(s), and end user transactions. Application workload is specified in the application model as discrete device actions for every discrete operation performed by the application or as aggregated loads 130 by data acquisition module 118. Discrete actions 128 are workloads generated by transactions towards hardware devices such as CPU, hard disk, etc. for various primary end user transactions. Such primary end user transactions include sending messages, opening messages, etc., that are performed repeatedly by users. Aggregated loads are specified in the form of continuous load in the form of discrete workload over a unit of time. Furthermore, aggregated loads 130 can include workloads on hardware devices for performing secondary user transactions (i.e., transactions performed infrequently) such as deleting messages, scheduling meetings, adding contacts, moving messages, etc. Aggregated loads 130 for a hardware device (e.g., CPU) may be expressed as number of cycles per second. Each activity of the actual modeled application is represented either by the aggregated load or by a transaction.

Performance models 132 may include application models 134 and device models 136. Application models 134 may relate to a variety of software applications running on servers and computing devices. Application models 134 may include details of operations involved in each software application component and action costs for hardware devices required to perform such operations and the aggregated loads associated with application component models. Such software applications may relate to distributed applications that may include but are not limited by messaging systems, monitoring systems, data sharing systems, and any other server applications, etc.

For example, an administrator may need to create a wired network such as a LAN in an office environment that enables multiple users (i.e., employees) to communicate using a local messaging system. In such a scenario, workload generation module 120 may analyze the application specific information, device loads 128, and aggregated loads 130 (i.e., server resource consumption in terms of speed or load over time, etc.) to compute the specific values of the aggregate loads and to identify transaction rates and secondary end user operations. Before starting the simulation of discrete transactions, the model generating module 120 determines specific target instances of device models for each aggregate load and calls the corresponding device model to apply the aggregate load. Then the model generating module 120 creates series of discrete transactions to be simulated to estimate statistical characteristics of response time for individual business functions or the transactions performed by such models. The business functions may include functions related to core business activities and maintenance functions, where the maintenance functions have less valuable response time than core business activities.

Performance models 132 may be expressed using an application modeling language that may be based on a XML schema, to combine the definition of discrete transactional and aggregated loads 130. An aggregated load element may be added to the application definition of the application modeling language to enable declaration of named units of continuous resource consumption. Continuous aggregated loads 130 may be defined or implied that the latency in consuming the resource may not be computed.

Details of an aggregated load specification (i.e., aggregated loads 130) may depend on the type of resource being consumed by the load (aggregate load). For example, the following types of aggregate loads may be declared: processor aggregate load, storage aggregate load, and network aggregate load. Therefore, for example, attribute schemas for XML elements representing these load types are also different. In particular, processor aggregate load may be defined as the fraction of processor utilization on the reference processor unit. Storage aggregate load is defined as a combination of the following attributes: type of the storage IO operations (read or write), pattern of the IO operation (random or sequential), number of IO operations per second, and number of bytes read or written per second. Network aggregate load may be defined as: type of the network IO operation (send or receive), and number of bytes sent or received per second

An example of the XML application model defining the aggregate load is shown below:

```
<Component Id=“BackEndSQL” Name =“BackEndSQL”>
    ...component parameter declaration...
  <AggregatedLoads>
  <AggregatedLoad
        Id =“DatabaseCleanup”
        Name =“Database cleanup load”>
    <ProcessorLoad
            ReferenceConfiguration =“CPU1”
            Utilization =“0.047”/>
    <StorageLoad
            Operation =“Read”
            Pattern=“Random”
            losPerSecond=“1.3”
            BytesPerSecond=“1200”/>
    <StorageLoad
            Operation=“Write”
            Pattern=“Random”
            losPerSecond=“0.2”
            BytesPerSecond=“320”/>
  </AggregatedLoad>
  <AggregatedLoad
        Id =“Reindex”
        Name =“Reindex job”>
    <ProcessorLoad
            ReferenceConfiguration =“CPU1”
            Utilization =“0.07”/>
    <StorageLoad
            Operation =“Read”
            Pattern=“Random”
            losPerSecond=“1.3 * @Component.LoadIOCoeff”
            BytesPerSecond=“1200 * @Component.LoadBytesCoeff”/>
    <StorageLoad
            Operation=“Write”
            Pattern=“Random”
            losPerSecond=“0.2”
            BytesPerSecond=“320”/>
  </AggregatedLoad>
  </AggregatedLoads>
    ...methods declarations...
</Component>
```

In this example, the component “BackEndSQL” declares two distinct aggregate load models “DatabaseCleanup” and “Reindex”. “DatabaseCleanup” aggregate load consists of a processor aggregate load and two storage aggregate loads one for the Write and another for the Read operations. “Reindex” aggregate load also declares one processor and two storage loads, but in this case the numeric values of the load parameters are not constant, which is apparent from the form of the IosPerSecond attribute value: 1.3*@Component.LoadIOCoeff”. The number of I/O operations per second generated from this aggregate load is computed dynamically at the time of model simulation and depends on the value of the component parameter “LoadIOCoeff”. In turn, “LoadIOCoeff” can be either computed in the initialization method of the component or set by the end user of the simulation tool. This flexibility allows the aggregate loads to be adjustable to the model deployment variations or user input.

The schema for defining the aggregated load may be distinctively different that the schema for defining the discrete resource actions. As described above, a difference is that the aggregated load defines the resource consumption over a unit of time (i.e. “resource consumption speed”), while for the discrete transactions load is defined in the units of resource consumption per transaction.

Since the aggregated load can be divided in named groups, the model execution engine 124 to calculate the contribution of the load units to the resource utilization separately. For example, as a result of such execution the following results can be computed for the CPU utilization (i.e., a sample set of results based on the XML model above):

| | |
|---|---|
| Total CPU Utilization: | 56% |
| Aggregated load | |
| Database cleanup: | 5% |
| Reindex: | 8.5% |
| Transactions | |
| Store data transaction: | 30% |
| Retrieve data transaction: | 15.5% |

### Model Execution

The execution of discrete transactions by simulation engine or simulation module 122 is described in detail in referenced U.S. patent application entitled “Dynamic Transaction Generation For Simulating Distributed Systems” by Efstathios Papaefstathiou, John M. Oslake, Jonathan C. Hardwick, and Pavel A. Dournov; having Ser. No. 11/394,474, filed on Mar. 31, 2006.

The general principle and the device type specific details for executing the aggregated loads during simulation are described below.

In an exemplary implementation, the simulation engine or simulation module 122 receives an application deployment as its input for simulation, where the application deployment includes inputs from application models 134 and device models 136.

The application model 134 can define aggregated loads within application components and the deployment objects specify the mapping of these loads to hardware devices represented by instances of the device models 136.

Before starting the discrete transaction simulation the simulation engine or simulation module 122 may run the following procedure: 1) Run all initialization methods of the application model to compute parameter values that are used in the expressions of the aggregated load definitions; 2) For each component instance in the deployment, a) for each aggregate load declared for the component in the application model perform the following: i. compute the load parameters, ii. consult the application deployment model to determine the set of devices mapped to the aggregate load, iii. apply the aggregate load to the corresponding device model instances

The procedure of applying the aggregate loads may not depend on the device type from the simulation engine (simulation module 122) stand point. This may be achieved through a common generic protocol between the simulation engine (simulation module 122) and device models 136 that includes a single function call from the simulation module to the device model. The call has a named instance of the aggregate load as a parameter and instructs the device model to perform necessary computation to consider the effects of the aggregated load in subsequent simulation of discrete transactions.

The device models 136 implement specifics of applying the aggregate load with the device type specific schema to the device model itself. Typically, the specific of applying the load depends on the device type and the device structure.

Functionally, the aggregate load application procedure offsets the available capacity of the device assigned to the given aggregated load. Device capacity is reduced in a way that would make the device model to: 1) increase the latency of individual transaction requests accordingly to simulate the aggregate load impact on the latency of the foreground transactions; 2) set the lower boundary for the instantaneous utilization since the device may not be idle under the aggregate load event when no foreground transactions occupy the device.

The amount of capacity offset may be calculated by an algorithm residing within the device model which keeps the modeling platform independent on the particular model implementations. Capacity offset is cumulative, such that the simulation engine (simulation module 122) can present several aggregated loads to the device model (of device models 136) and the model will accumulate the total effect of all the loads. It is noted that the device model (of device models 136) performs the necessary resealing of the load to the target configuration if necessary. For example, if the aggregate load is declared as 25% of the reference Pentium III CPU with 1 Ghz clock speed and the target CPU is 2 Ghz Xeon the CPU device model computes the actual utilization offset on the target CPU using the ratio of the reference and the target CPU configuration parameters which result in a aggregate load applied being less than 25%.

### Protocol for Applying the Aggregate Load to the Device Models

A example of a protocol of applying the aggregate load is an extension of the protocol <device model protocol> as described in detail in referenced U.S. patent application entitled “Dynamic Transaction Generation For Simulating Distributed Systems” by Efstathios Papaefstathiou, John M. Oslake, Jonathan C. Hardwick, and Pavel A. Dournov; having Ser. No. 11/394,474, filed on Mar. 31, 2006.

In the protocol of the referenced patent application, the device model interface and the interaction protocol between the simulation engine (simulation module 122) and the device models 136 is extended in order to accommodate the aggregate load concept. In particular, the following method is added to the device model interface (i.e., an interface that is implemented by all device model classes):

void ApplyAggregateLoad(AggregateLoad aggregateLoad)

where AggregateLoad is the base class for the load type specific aggregate loads.

There are three subclasses of the base AggregateLoad class and are as follows:

ProcessorAggregateLoad

StorageAggregateLoad

NetworkAggregateLoad

The schemas for these subclasses match the schemas for respective XML elements in the XML schema for defining the aggregate loads in the application models.

The method ApplyAggregateLoad is invoked in the above algorithm.

### Device Specific Implementations of the Aggregated Load

The method for applying the aggregate load to a device model may depend on whether the device model implements a shared or queue based device.

A shared device is a device with no request queue in which all arriving discrete workload requests from transactions get scheduled for processing on the device immediately at arriving. The shared device can process multiple discrete workload requests (referred to as “request” below) simultaneously. Usually the shared device performance depends on the number of request being processed simultaneously.

A queue based device allows a limited number of requests to be processed at a moment of time. The number of requests may be limited to one or any other number including cases where the limit can be adjusted dynamically. As requests may arrive to the device while it is busy, the device may have a queue where such requests are placed until the device becomes available. The requests can be pulled from the queue using different methods, for example FIFO (first in-first out), FILO (first in-last out), etc.

### Shared Devices

For example, in the context of a capacity planner modeling framework the following devices are modeled as shared devices: processor, network interface, WAN link, and SAN interconnect.

The device models of the shared devices maintain the maximum device speed which is the speed of the device when only one request is present. Since the aggregate load represent some continuous activity on the device, the presence of the aggregate load slows the device down effectively reducing the speed of processing the discrete requests.

To compute the offset of the processing speed, when an aggregate load is presented to the device model of a shared device the device model performs the following computation:

new_speed=original_speed*(1.0−total_aggregate_utilization)

Where new_speed—is the effective maximum speed of the device for discrete requests considering the aggregate load; original_speed—is the speed of the device with no aggregate load; and total_aggregate_utilization—is the device utilization due to aggregate load.

The total_aggregate utilization is the utilization of the device that is reported to the simulation engine when the device is not occupied by any discrete workload requests.

FIG. 2 shows device utilization changes during simulation time once aggregated load is not considered. Simulating module 122 performs discrete simulation of a hardware device for performing multiple end user transactions to generate an activity pattern 200. Activity pattern 200 shows a point 202 at which the hardware device (e.g., CPU) may be busy performing an end user transaction and percentage (e.g., 100 percent) utilization of resources (e.g., CPU). This transaction may require for example, 5 mega cycle on a particular CPU. At point 204, the hardware device may be free from performing any end user transactions. Line 206 denotes an average percentage of device utilization for time of simulation.

FIG. 3 shows a device utilization changes during simulation time once aggregated load is considered. Simulating module 122 performs discrete simulation of the hardware device events as directed by the application model transactions by adjusting the capacity of the device by the sum of all aggregated loads 130 to generate an activity pattern 300. Activity pattern 300 shows a point 302 at which the hardware device (e.g., CPU) may be busy performing an end user transaction and percentage (i.e. 100 percent) utilization of resources of CPU may be needed. For example, the end user transaction may require 5 mega cycle on a particular CPU. At point 304, the hardware device may be free from performing any end user transactions. A line 306 denotes an average percentage of device utilization for each end user operations. Furthermore, the capacity offset due to aggregated loads 130 is denoted as 308 in activity pattern 300. Thus the conversion of the discrete transactions to the aggregated loads 130 may enable prevention of redundant computations to obtain statistical information of the application transactions and device utilization.

### Queue Based Devices

In the capacity planner modeling framework the device model of an individual disk may be implemented as a queue based model. This model may also be used within more complex storage models of the RAID controller and the disk group model.

For the queue based model the aggregate load is defined as a “number of requests of the given type and size over time”. For example, a disk aggregated load is defined as “number of random read 10 in a second and number of bytes in second” which effectively means “number of random read 10 with the given average size in second”.

To simulate the effect of the aggregate load on the queue based device the device model provides a function that computes the additional queue delay due to the aggregate load for every transaction request arriving to the device. The disk model for instance achieves this by effectively simulating the aggregate load requests internally without involving the full cycle of the simulation module.

FIG. 4 shows graphs 400 representing transactions related to aggregate load simulation of a queue based device.

Graph 402 represents the arrivals of the transaction requests. Graph 404 shows restored aggregate load requests. The aggregate load requests are restored, in this example, with an assumption of the evenly spaced arrival times of the aggregate load requests. The device model is free to make other choices for this parameter to improve the accuracy of the simulation. The choice of the inter arrival distribution does not impact the overall protocol of the model functionality.

Graph 406 shows how the transaction requests are shifted as a result of collision with aggregate load requests (for example, T2 is shifted by the time needed to complete processing of b3). The aggregate load requests can also be shifted by the transaction requests which may in turn result in a shift for the subsequent transaction request (see T3, b6, and T4 requests).

Since the simulation engine (simulation module 122) computes latencies for transaction requests, the device model (device models 136) provides this latency adjusted to the aggregate load using the following formula:

new_request_latency=original_request_latency+aggregate_load_delay(t)

Where:

new_request_latency—result service time for the transaction request;

original_request_latency—initial service time of the transaction request without considering the aggregate load;

aggregate_load_delay—function that computes the additional queue delay of the transaction requests due to the aggregate load;

t—arrival time of the transaction request.

Graph 408 of FIG. 4 shows device utilization as reported by the device model 136. The utilization is computed by the following algorithm.

When the device does not process any transaction requests, the device reports the aggregate load utilization as the background utilization that is computed as below:

$${u}_{a} = {\sum }_{a ∈ A} {f}_{a} {l}_{a} , where$$

uₐ is the utilization due to the aggregate load;

A is the set of all aggregate loads applied to the device;

fₐ is the frequency of a^{th} aggregated load; and

lₐ is the latency of the requests from the a^{th} aggregated load.

When the device is busy with a transaction request, the reported utilization is computed as:U

$${u}_{d} = \frac{l + {u}_{a} d}{l + d} , where$$

u_{d} is the average device utilization for the period of processing the given transaction request;

l is the latency of the transaction request currently in the device without the delay due to aggregate load;

d is the delay due to aggregate load; and

uₐ is the utilization due to the aggregate load;

The computations in the queue based device model are performed at moments of the transaction requests arrivals. This allows the possibility to improve the speed of simulation using the method described below.

### Simulation Acceleration

The concept of aggregated load simulation opens the possibility for accelerating the overall simulation process. A discrete event simulation implemented by a performance modeling platform is based on the idea of simulating multiple simultaneous transactions and determining the effects of these transactions to the devices and thus computing the device utilization and the transaction latency characteristics.

In order to obtain sufficient information about the simulated system an engine simulates multiple instances of every transaction in the system and collects statistical information about the devices and transaction types. Simulation of a transaction from a given transaction source takes approximately the same amount of time. The time of simulating a transaction is usually small, much smaller than the actual time of running this transaction in the real system. However, the actual still has a value (i.e., it's still greater than zero), and under certain conditions the total simulation time may be too big for an interactive user experience (e.g., sometimes hours). The cause of this problem is in the statistical nature of the discrete simulation. In order to gather sufficient statistics for transactions the simulation engine runs every transaction multiple times (more than 100) and since the engine considers the transaction rates the total number of transactions to simulation may be very large which prevents the simulation process from scaling.

For example, suppose there are two transaction sources in the system and the rates of the transactions to be generated from these sources are r1 and r2 (in transactions per second). Then, in order to generate N transactions of each type the engine needs to run through MAX(N*r1, N*r2) simulated seconds. If r2 is significantly greater than r1 (i.e. r1/r2>>1) then during the simulation time the engine is to simulate N transactions of type 2 and N*r1/r2 transactions of type 1. Since the time t for simulating one transaction is approximately constant the total simulation time will be (N+N*r1/r2) which may be a very long time if the ratio r1/r2 may be big (as mentioned above).

### EXEMPLARY METHOD

An exemplary method to solve the scalability problem and improve the speed of the simulation. The method can be summarized in the following algorithm and may be described in the general context of computer executable instructions. Generally, computer executable instructions can include routines, programs, objects, components, data structures, procedures, modules, functions, and the like that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

FIG. 5 illustrates an exemplary method 500 for solving the scalability problem and improving the speed of the simulation. This method reduces the amount of redundant computations that normally occur in discrete simulations by performing computations that are needed for a particular set of expected simulation results. Application of the method results in improved simulation speed and better scalability of the simulation engine.

The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

At block 502, simulation is started normally by generating all transactions in a normal discrete manner.

At block 504, statistics are collected while simulation is running. The statistics particularly include transactions and the impact of the transactions upon devices.

At block 506, the following are performed (e.g., performed by the simulation module 122), when statistical data points related to a transaction are converged or in other words, when the statistical confidence interval is within a preset range: a) compute capacity consumption portion related to transaction for devices hit by the transaction; b) convert the capacity portions to aggregated loads; c) apply the aggregated loads to respective devices; d) disable the transaction from further generation in the simulation run.

At block 508, excluding the transaction from the simulation.

At block 510, continuing the simulation with other transactions.

At block 512, stopping the simulation when all transactions are converted to the aggregated loads.

### EXEMPLARY COMPUTER

FIG. 6 shows an exemplary computing device or computer 600 suitable as an environment for practicing aspects of the subject matter. In particular, computer 600 may be a detailed implementation of computers and/or computing devices described above. Computer 600 is suitable as an environment for practicing aspects of the subject matter. The components of computer 600 may include, but are not limited to processing unit 605, system memory 610, and a system bus 621 that couples various system components including the system memory 610 to the processing unit 605. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as the Mezzanine bus.

Exemplary computer 600 typically includes a variety of computer-readable media. Computer-readable media can be any available media that can be accessed by computer 600 and includes both volatile and nonvolatile media, removable and non-removable media. By way of example, and not limitation, computing device-readable media may comprise computer storage media and communication media. Computer storage media include volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 600. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computing device readable media.

The system memory 610 includes computing device storage media in the form of volatile and/or nonvolatile memory such as read only memory (ROM) 631 and random access memory (RAM) 632. A basic input/output system 633 (BIOS), containing the basic routines that help to transfer information between elements within computer 600, such as during start-up, is typically stored in ROM 631. RAM 632 typically contains data and/or program modules that are immediately accessible to and/or presently being operated on by processing unit 605. By way of example, and not limitation, FIG. 6 illustrates operating system 634, application programs 635, other program modules 636, and program data 637.

The computer 600 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computing device storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface such as interface 650.

The drives and their associated computing device storage media discussed above and illustrated in FIG. 6 provide storage of computer-readable instructions, data structures, program modules, and other data for computer 600. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the exemplary computer 600 through input devices such as a keyboard 648 and pointing device 661, commonly referred to as a mouse, trackball, or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port, or in particular a USB port.

A monitor 662 or other type of display device is also connected to the system bus 621 via an interface, such as a video interface 690. In addition to the monitor 662, computing devices may also include other peripheral output devices such as speakers 697 and printer 696, which may be connected through an output peripheral interface 695.

The exemplary computer 600 may operate in a networked environment using logical connections to one or more remote computing devices, such as a remote computing device 680. The remote computing device 680 may be a personal computing device, a server, a router, a network PC, a peer device or other common network node, and typically includes many or all of the elements described above relative to computer 600. The logical connections depicted in FIG. 6 include a local area network (LAN) 671 and a wide area network (WAN) 673. Such networking environments are commonplace in offices, enterprise-wide computing device networks, intranets, and the Internet.

When used in a LAN networking environment, the exemplary computer 600 is connected to the LAN 671 through a network interface or adapter 670. When used in a WAN networking environment, the exemplary computer 600 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the exemplary computer 600, or portions thereof, may be stored in a remote memory storage device. By way of example, and not limitation, FIG. 6 illustrates remote application programs 685. It will be appreciated that the network connections shown are exemplary and other means of establishing a communications link between the computing devices may be used.

### CONCLUSION

The above-described methods and computers describe a way for definition and execution of performance models for distributed systems composed of specifications of discrete and continuous workloads. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
constructing performance models of distributed applications that define aggregated continuous resource consumptions along with discrete resource actions allowing for flexibility in defining performance models to better match modeling scenarios.

2. The method of claim 1, wherein the aggregated resource consumption represents processor load.

3. The method of claim 1, wherein the aggregated resource consumption represents storage subsystem load.

4. The method of claim 1, wherein the aggregated resource consumption represent network interface load.

5. The method of claim 1, wherein the aggregated resource consumption load is defined in the units of discrete load over a unit of time.

6. A domain specific language for defining hybrid performance models of distributed application comprising:
schemas for defining the aggregate resource consumption loads for different resource types, and
methods for processing the models.

7. The domain specific language of claim 6, wherein the schemas comprise schema for processor aggregate load defining processor aggregate load as percent of utilization of a reference processor configuration.

8. The domain specific language of claim 6, wherein the schemas comprise schema for storage aggregate load defining storage aggregate load as an averaged storage input output operation over a unit of time;

9. The domain specific language of claim 6, wherein the schemas comprise schema for network aggregate load defining network aggregate load as average network input output operation over a unit of time.

10. The domain specific language of claim 6, wherein the schemas comprise schema for aggregate load definition that allows for multiple aggregated loads to be defined within application components, and wherein each aggregate load is identifiable by an identifier.

11. The domain specific language of claim 6, wherein the schemas comprise schema for aggregate load definition that allows free form arithmetic expressions in a load value declaration and ability to reference values of other model parameters.

12. A method comprising:
executing performance models of distributed applications that contain discrete transactional load along with aggregate load definitions; and
computing the device and transaction performance statistics considering a combined effect of discrete and aggregate loads.

13. The method of claim 12, wherein the aggregate load definition is applied to a device model modeled as a shared device and in which the speed of the shared device is offset by the aggregate load value before simulating discrete transaction on the device model.

14. The method of claim 12, wherein utilization of devices due to aggregate load is computed and reported for each named aggregate load individually.

15. The method of claim 12, wherein device models expose a uniform interface that allows application of aggregate loads at any time during simulation and effect of the aggregated load is factored into computations made by a device model for discrete transaction after the application of the aggregate load.

16. The method of claim 12 further comprising processing the aggregate load definitions as applied to a queue based device model; wherein the queue based device model computes the effect of aggregate load by generating individual requests representing an aggregate load at the moment of arrivals of the transactional load requests.

17. A method comprising:
accelerating discrete event simulation based on collecting statistical data for each transaction source and device, and
converting discrete transactions to aggregated loads which do not require repetitive computations for determining the device performance statistics.

18. The method of claim 17, wherein a simulation engine computes contribution of every transaction source to device utilization and determines when a statistical average of the contribution is stable.

19. The method of claim 17, wherein a simulation engine converts device utilization statistics per transaction to aggregate loads, applies the aggregate loads to the corresponding devices

20. The method of claim 19, wherein the simulation engine disables the converted transactions from further simulation achieving overall acceleration of the simulation.
